(19) United States
(12) Patent Application Publication
(10) Pub. No.: US 2013/0248093 A1
(43) Pub. Date: Sep. 26, 2013

(54) COMPOSITE STRUCTURE FORMING ON COEFFICIENT OF THERMAL EXPANSION MISMATCHED TOOLING

(71) Applicants: Steven Fillmore Hanson, Derby, KS (US); Randy R. Kysar, Derby, KS (US)

(72) Inventors: Steven Fillmore Hanson, Derby, KS (US); Randy R. Kysar, Derby, KS (US)

(73) Assignee: SPIRIT AEROSYSTEMS, INC., Wichita, KS (US)

(21) Appl. No.: 13/428,041

(22) Filed: Mar. 23, 2012

(51) Int. Cl. B29C 53/36; B29C 63/06

(52) U.S. Cl. 156/218; 156/475

(57) ABSTRACT

A mandrel used with forming composite parts includes an outer surface on which composite material is placed, and a groove in which splice material is filled. The groove may be positioned on the outer surface along the length of the mandrel. A method for forming composite parts includes the steps of providing a mandrel that includes a groove aligned with its longitudinal axis, filling the groove with splice material, cutting the composite material to match the shape and the size of the mandrel, placing the composite material around the outer surface of the mandrel, and curing the composite material and the mandrel.

### BACKGROUND OF THE INVENTION

1. Field of the Invention

Embodiments of the present invention relate to systems and methods for forming composite structures. More particularly, embodiments of the present invention relate to systems and methods for forming composite structures with a forming tool that has a large coefficient of thermal expansion.

2. Description of the Related Art

Composite structures may be formed by winding composite material, such as carbon fiber, around a mold, or mandrel, in the shape of the final structure. The combination of the mandrel and the composite material is often subjected to high temperature in order to cure the composite material. Wrapping the material around the mandrel may form a closed loop. During heating, both the mandrel and the material will expand. If the coefficient of thermal expansion (CTE) of the mandrel is greater than the CTE of the material, then the mandrel will experience greater expansion than the material. If the material is wound tightly against the mandrel, then the expansion of the mandrel will exert a force on the material that creates tension in the fibers. A large enough tension may break a sufficient number of fibers to weaken the final structure and render it unusable.

### SUMMARY OF THE INVENTION

Embodiments of the present invention solve the above-mentioned problems and provide a distinct advance in the art of forming composite structures. More particularly, embodiments of the invention provide a method for forming composite structures with a mandrel that has a greater coefficient of thermal expansion than that of the composite structure material.

A mandrel is provided in the shape of a composite part in its final form. The mandrel may include an outer surface on which composite material is placed, and a groove in which splice material is filled. The groove may be positioned on the outer surface along the length of the mandrel. The groove may also provide a path along which first and second ends of the composite material are aligned such that the composite material contacts the splice material and bonds to the splice material when the composite material and the mandrel are cured. A method for forming the composite part includes the steps of providing a mandrel that includes a groove aligned with its longitudinal axis, filling the groove with splice material, cutting the composite material to match the shape and the size of the mandrel, placing the composite material around the outer surface of the mandrel, and curing the composite material and the mandrel.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a mandrel including a longitudinal groove used to form a composite structure in accordance with various embodiments of the present invention;

FIG. 2 is an enlarged front view of the groove;

FIG. 3 is a perspective view of the mandrel depicting the groove filled with splice material;

FIG. 4 is an enlarged front view of the groove filled with splice material;

FIG. 5 is a perspective view of the mandrel depicting a cut in the composite material over the groove;

FIG. 6 is an enlarged front view of the groove depicting the cut in the composite material over the groove;

FIG. 7 is a perspective view of a finished composite structure; and

FIG. 8 is a flow diagram depicting a least a portion of the steps of a method of forming composite parts.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

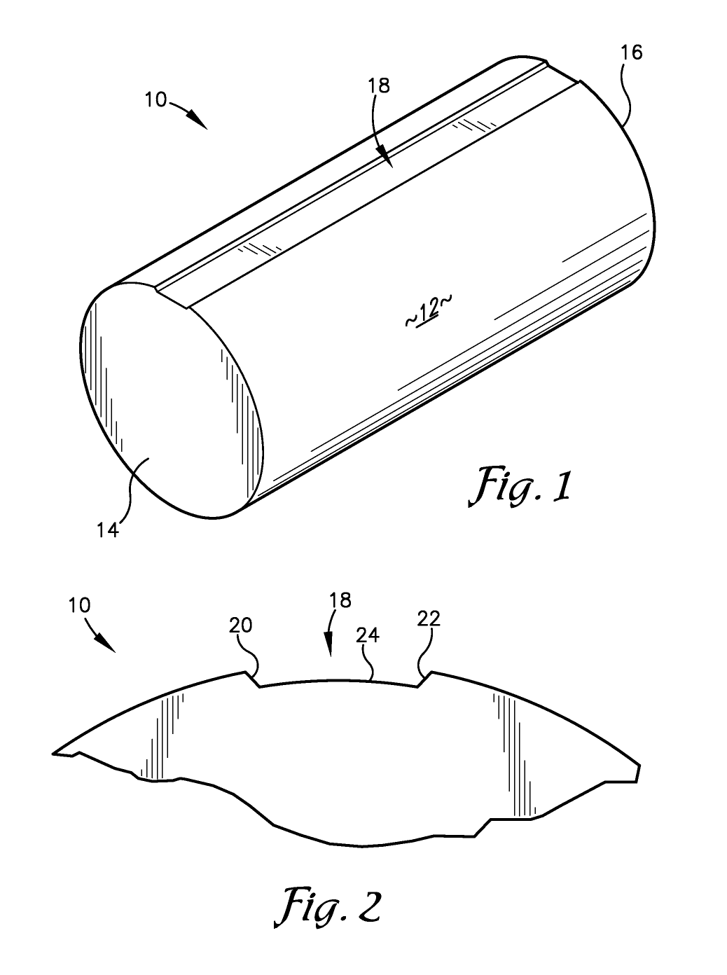

A mandrel 10 for forming composite structures using composite material, constructed in accordance with various embodiments of the current invention, is shown in FIGS. 1-6. The mandrel 10 may present the shape of the composite structure to be formed. For example, when forming a composite structure used to manufacture an aircraft fuselage, the mandrel 10 may present a generally elongated cylindrical shape with dimensions that are similar to those of the fuselage. In various embodiments, the mandrel 10 may be solid. In other embodiments, the mandrel 10 may be hollow or have a generally tubular shape. The mandrel 10 is typically constructed from a metal, such as aluminum, that can withstand compressive forces when the composite structure is being formed. Generally, the mandrel 10 includes an outer surface 12 along its circumference, a first end 14, and an opposing second end 16. The mandrel 10 may have an exemplary diameter of approximately 6 feet to approximately 30 feet and an exemplary length of approximately 10 feet to approximately 100 feet.

The mandrel 10 further includes a groove 18 that is generally positioned on the mandrel 10 in the area or areas where composite material fibers will be wound. Furthermore, the groove 18 is typically oriented such that at any point along the groove 18, the groove 18 is positioned transverse or at an approximate right angle to the direction of the winding of the fibers. In various embodiments, the groove 18 may have a shape as required by the final part. In some embodiments, the groove 18 may have a curvature along its length. In exemplary embodiments, the groove 18 may be positioned along the outer surface 12 and in alignment with the longitudinal axis of the mandrel 10 such that the groove 18 extends from the first end 14 to the second end 16. The groove 18 may include a first sidewall 20 and an opposing second sidewall 22 that extend inward from the outer surface 12 of the mandrel 10 at an angle. A generally curved bottom wall 24 (that matches the curvature of the mandrel 10) may connect from the first sidewall 20 to the second sidewall 22. In various embodiments, the first sidewall 20, the second sidewall 22, and the bottom wall 24 may have different shapes, dimensions, or relative angles, such that the groove 18 may have a variety of cross-sectional profiles. An exemplary groove 18 may have dimensions of approximately 6 inches to approximately 24 inches in width. In general, the groove 18 is shaped to retain material that is placed within the groove 18 to form a co-cured splice.

The composite material 28, as shown in FIGS. 5-6, generally includes at least two constituent components—a reinforcement material and a matrix material. The reinforcement material generally provides mechanical strengthening properties, such as high tensile strength, to the composite material, while the matrix material acts as a binder to hold the reinforcement material together. The reinforcement material and the matrix material may possess additional properties not discussed herein. Furthermore, the composite material may include additional components not discussed herein.

Examples of the reinforcement material that may be used with the current invention include, but are not limited to, fiber materials such as carbon fiber, boron fiber, fiberglass, aramid fiber, ceramic fiber, and the like. In the case of fiber-based reinforcement materials, the fiber may exist in one of at least two forms—either preimpregnated (prepreg), in which the fiber may be coated with a matrix material that is uncured, such as uncured resin, or as dry fiber, with no matrix material incorporated prior to part manufacture. The matrix material may typically be in the form of polymer resins, such as epoxies, bismaleimides, vinyl esters, and the like, among others.

The composite material 28 may exist in a fiber or bundle of fibers form, or it may exist as a sheet or a weave of fibers.

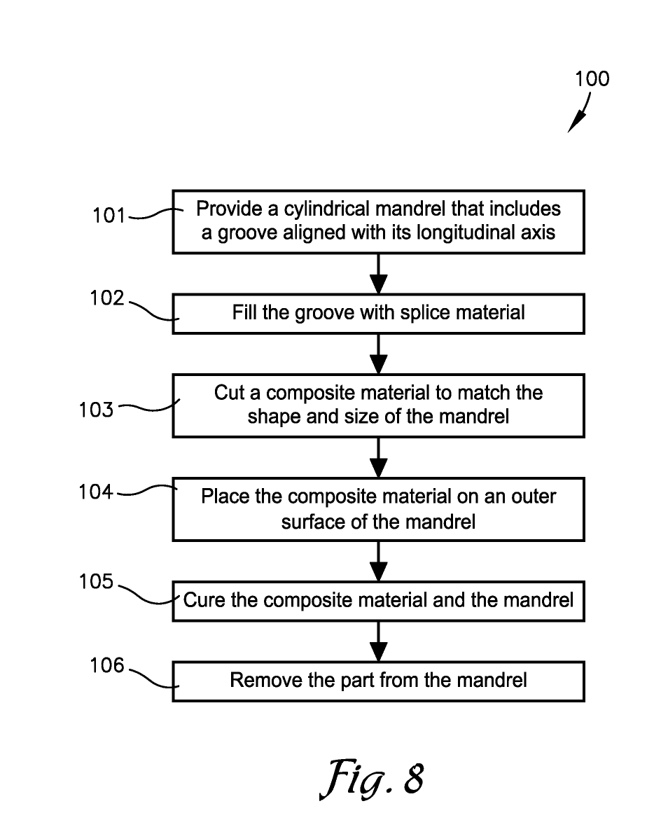

At least a portion of the steps of a method 100 of forming composite structures using the mandrel 10 in accordance with various embodiments of the present invention is listed in FIG. 8. The steps may be performed in the order as shown in FIG. 8, or they may be performed in a different order. Furthermore, some steps may be performed concurrently as opposed to sequentially. In addition, some steps may be omitted.

Referring to step 101, a mandrel 10 is provided that includes a groove 18 aligned with its longitudinal axis, as seen in FIGS. 1-2. In some embodiments, more than one mandrel 10 may be provided. The mandrel 10 may present other shapes as necessary to match the shape of the final part to be formed. The mandrel 10 may include an outer surface 12 in which the groove 18 is placed, such that the groove 18 extends from a first end 14 of the mandrel 10 to an opposing second end 16. The groove 18 may further include a first sidewall 20, a second sidewall 22, and a bottom wall 24, and may be formed using techniques such as machining.

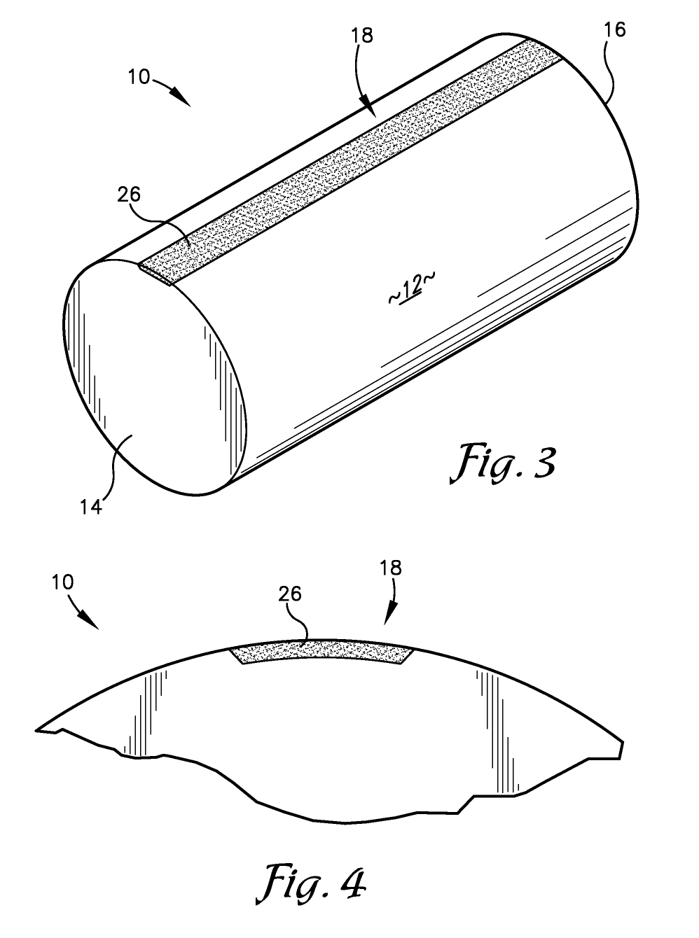

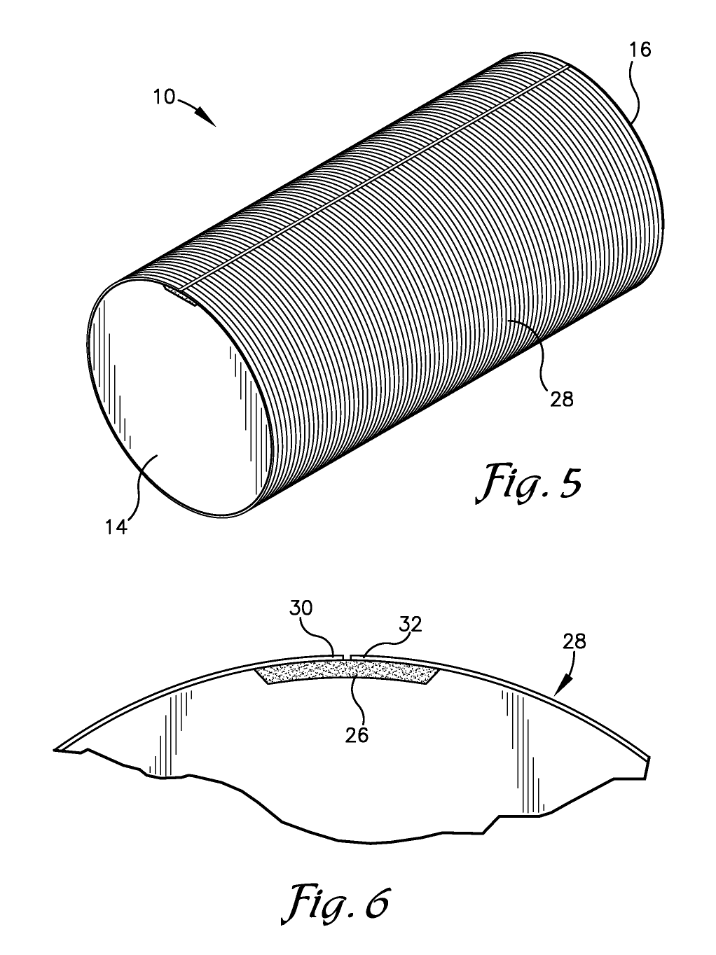

Referring to step 102, the groove 18 is filled with composite material, as seen in FIGS. 3-4, referred to as splice material 26, which may be cured or uncured. In some embodiments, the splice material 26 may also be a metal such as titanium.

Referring to step 103, the composite material 28 is cut to match the size and shape of the mandrel 10. In the case of fiber or fiber bundle composite material 28, the composite material 28 is cut to form strands with a length that is approximately equal to the circumference of the mandrel 10. If the composite material 28 is a sheet or a weave, then the composite material 28 is cut to have a width approximately equal to the circumference of the mandrel 10. Cutting the composite material 28 generally creates a first material end 30 and a second material end 32 on opposing sides of the composite material 28.

Referring to step 104, the composite material 28 is placed on the mandrel 10, such that the first material end 30 and the second material end 32 abut each other over the groove 18 and the splice material 26. The composite material 28 may be placed using automated techniques or manual techniques. In various embodiments, fiber tow placement may be used to place the composite material 28 on the mandrel 10. Generally, after placement, the first material end 30 and the second material end 32 should touch or abut one another over the center of the groove. In addition, it is desirable for the first material end 30 and the second material end 32 to touch one another, although a gap therebetween of up to 0.05 inches may be acceptable.

Referring to step 105, the mandrel 10, the composite material 28, and the splice material 26 are cured. The curing may be performed in an autoclave or an oven. During the curing, the mandrel 10 may expand as a result of the high temperature. The circumference of the mandrel 10 may increase thereby creating tension on the composite material 28 and increasing the separation distance between the first material end 30 and the second material end 32. The portions of the first material end 30 and the second material end 32 that contact the splice material 26 may bond to the splice material 26 and cure as a unit such that the composite material 28 (including the first material end 30 and the second material end 32) and the splice material 26 form a single monolithic finished composite part 34.

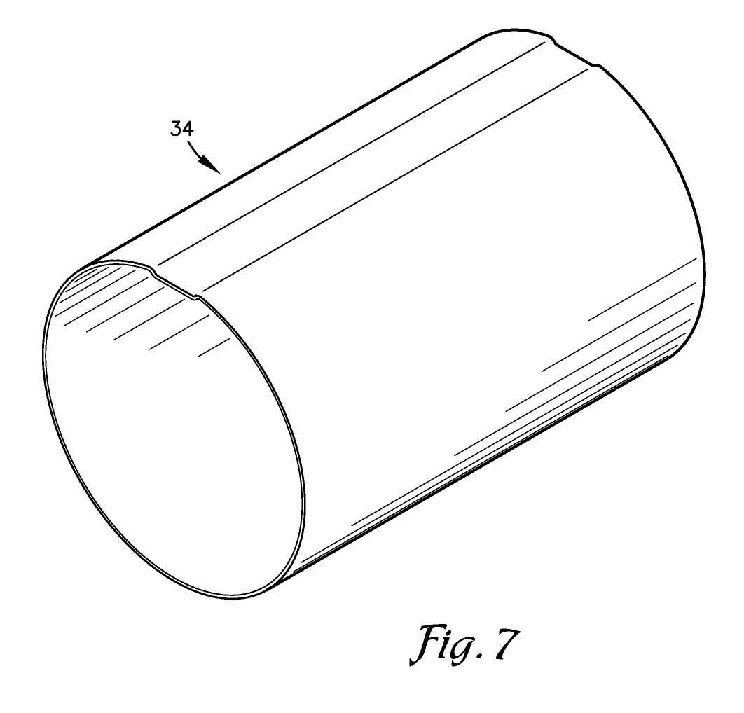

Referring to step 106, the part 34, shown in FIG. 7, is removed from the mandrel 10. The part 34 is generally ready for use.

The method of various embodiments of the current invention allows for lighter weight, lower cost metals with a relatively higher coefficient of thermal expansion, such as aluminum, to be used for the mandrel 10 while still providing a monolithic finished composite part. Furthermore, the method results in virtually no broken fibers and a reduced number of marcelled fibers. Thus, finished parts are of a higher quality for a lower cost.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A mandrel for use with forming composite parts, the mandrel comprising:
an outer surface on which composite material is placed; and
a groove in which splice material is filled, the groove positioned on the outer surface of the mandrel, the groove providing a path along which first and second ends of the composite material are aligned such that the composite material contacts the splice material.

2. The mandrel of claim 1, further including a cylindrical body with a first end and an opposing second end, wherein the groove is aligned with the longitudinal axis of the cylindrical body and extends from the first end to the second end.

3. The mandrel of claim 1, wherein the mandrel has a higher coefficient of thermal expansion than does the composite material.

4. The mandrel of claim 1, wherein the groove includes first and second sidewalls and a bottom wall to retain the splice material.

5. A method of forming composite material parts, the method comprising the steps of:
a) providing a mandrel that includes a splice groove aligned with its longitudinal axis;
b) filling the splice groove with splice material;
c) preparing a composite material to form a sheet with at least one dimension that matches a dimension of an outer surface of the mandrel, the sheet including a first edge and an opposing second edge;
d) placing the composite material on the outer surface of the mandrel such that the first edge is aligned with the second edge over the splice material in the splice groove;
e) curing the composite material and the mandrel such that the composite material and the splice material foam a monolithic part; and
f) removing the part from the mandrel.

6. The method of claim 5, wherein the splice material is uncured composite material.

7. The method of claim 5, wherein the splice material is cured composite material.

8. The method of claim 5, wherein the splice material is a metal.

9. The method of claim 5, wherein the mandrel has the shape of the final composite part.

10. The method of claim 5, wherein the mandrel is roughly cylindrical in shape.

11. The method of claim 5, wherein the splice groove includes a bottom surface with the same cross-sectional shape as the cross-sectional shape as an outer surface of the mandrel.

12. The method of claim 5, wherein the mandrel has a coefficient of thermal expansion that is greater than the coefficient of thermal expansion of the composite material.

13. A method of forming composite material parts, the method comprising the steps of:
a) providing a mandrel that includes a splice groove aligned with its longitudinal axis;
b) filling the splice groove with splice material;
c) placing a composite material including a plurality of fibers on an outer surface of the mandrel such that at least a portion of the fibers contact an outer layer of the splice material;
d) cutting the composite material to form a split in the composite material above the outer layer of the splice material in the splice groove along the entire length thereof;
e) curing the composite material and the mandrel such that the composite material and the splice material form a monolithic part; and
f) removing the part from the mandrel.

14. The method of claim 13, wherein at least a portion of the fibers of the composite material are placed on the mandrel at an angle transverse to the length of the splice groove.

15. A method of forming composite material parts, the method comprising the steps of:
a) providing a mandrel that includes a splice groove aligned with its longitudinal axis, the splice groove including a longitudinal first edge and an opposing longitudinal second edge;
b) filling the splice groove with splice material;
c) placing a first edge of a composite material in contact with the splice material such that a portion of the composite material overlays the first edge of the splice groove;
d) applying the composite material to an outer surface of the mandrel;
e) cutting the composite material to form a second edge of the composite material that opposes the first edge of the composite material;
f) aligning the second edge of the composite material with the first edge of the composite material over the splice material in the splice groove;
g) curing the composite material and the mandrel such that the composite material and the splice material form a monolithic part; and
h) removing the part from the mandrel.

16. The method of claim 15, wherein applying the composite material to the outer surface of the mandrel includes applying the composite material in a direction from the first edge of the splice groove across the outer surface of the mandrel to the second edge of the splice groove.
